(19) United States
(12) Patent Application Publication
(10) Pub. No.: US 2015/0019415 A1
(43) Pub. Date: Jan. 15, 2015

(54) AUTOMATIC CONSUMER DEBIT AND PAYMENT SYSTEM

(71) Applicant: David William Engelman, Austin, TX (US)

(72) Inventor: David William Engelman, Austin, TX (US)

(21) Appl. No.: 13/939,418

(22) Filed: Jul. 11, 2013

(51) Int. Cl. G06Q 20/10; G06Q 20/26

(52) U.S. Cl. CPC G06Q 20/102; G06Q 20/26
USPC 705/40

(57) ABSTRACT

Customers provide payday and creditor/biller information to a payment service, which determines the customer's aggregated monthly payments on periodic accounts such as vehicle loans and mortgages and then on each payday deducts a fraction of the aggregated amount in a single transaction, resulting in only a single fee to the customer. The fraction depends on how many times per month the customer is paid. The customer's funds are held in a trust account and on days that payment for a respective creditor is due during the month, the respective creditor is automatically paid out of the trust account.

### FIELD OF THE INVENTION

The present application relates generally to automatic consumer debit and bill payment systems.

### BACKGROUND

Bill paying is a task that is an unavoidable part of modern life. Like many other such tasks, bill payments have been sought to be automated by, for example, allowing consumers to authorize direct debits from their accounts to billers or to direct electronic bill payments via online banking functions.

As understood herein, most payment plans still require a certain amount of consumer action, fail to optimize debits from consumer accounts and payments to creditors in a way that reduces consumer interest charges, fail to allow budgeting advantageous of allowing consumers to make bill payments on dates convenient to their payday schedules, and fail to allow consumers to consolidate all their bill payments into a single debit at or near their paydays.

### SUMMARY OF THE INVENTION

Accordingly, a computer system includes one or more digital processors and one or more computer readable storage media accessible to the processor and bearing instructions which when executed by the processor configure the processor to execute logic to implement a service that includes accessing customer income receipt information associated with a customer. The customer income receipt information indicates when the customer receives income at respective future dates and/or times. The service includes accessing information related to at least first and second creditors to which the customer owes respective first and second payments, adding the first and second payments together to render an aggregated payment, and at one or more of the future dates and/or time, debiting an account of the customer by at least a pro rata portion of the aggregated payment in a single debit transaction such that the customer account is debited only once to cover both the first and second payments. The service also includes remitting to the first and second creditors the respective first and second payments from the aggregated payment.

In some implementations the customer income receipt information indicates a periodicity at which the customer receives payment from an employer. In example embodiments the service includes debiting the account of the customer by at least the pro rata portion of the aggregated payment in a single debit transaction at each of plural future dates and/or times. These first and second payments can be recurring charges owed to the respective first and second creditors. The service may also include debiting an account of the customer by at least the pro rata portion of the aggregated payment in a single debit transaction more than once per month, e.g., every two weeks, but remitting to the first and second creditors the respective first and second payments only once per month. In this case, the service includes debiting an account of the customer by at least the portion of the aggregated payment in a single debit transaction every two weeks for a calendar year such that an extra month's aggregated debt service amount is deducted from the account of the customer during the calendar year. At least part of the extra month's debt service amount may be used to establish an enrollment fee at least part of which is payable to an entity affiliated with the computer and/or an enrollment agent who enrolled the customer with the computer. If desired, only a single year's enrollment is required from the customer no matter how long the customer uses the service or how many additional debts the customer debtor adds to the service such that the customer does not have to pay for the service up front, with payment being made automatically and transparently to the service.

In another aspect, a computer system includes one or more digital processors and one or more computer readable storage media accessible to the processor and bearing instructions which when executed by the processor configure the processor to execute logic to implement a service that includes debiting a pro rata aggregated debt service amount from an account of a customer every two weeks for a calendar year such that an extra month's aggregated debt service amount is deducted from the account of the customer during the calendar year. At least part of the extra month's debt service amount is used to establish an enrollment fee at least part of which is payable to an entity affiliated with the computer and/or an enrollment agent who enrolled the customer with the computer. The service automatically pays multiple customer creditors from amounts debited from the account of the customer.

In another aspect, a method includes receiving customer paycheck and creditor information at a server implementing an aggregated debt payment service. The method includes using the server to determine a customer's aggregated monthly payments on periodic accounts, and on each payday of the customer, using the server to deduct a fraction of the aggregated monthly payment in a single transaction, resulting in only a single fee to the customer, with the fraction depending on how many times per month the customer is paid. The customer's funds are held in a service account, and on days that payment for a respective creditor of the customer is due, the respective creditor is paid out of the service account automatically and transparently to the customer.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a block diagram of an example system according to present principles;

FIG. 2 is a flow chart showing example overall logic according to present principles;

FIG. 3 is a flow chart showing example enrollment logic;

FIG. 4 is a flow chart showing example payment logic;

FIG. 5 is a flow chart showing details of example deduction logic; and

FIG. 6 is a flow chart of example accelerated payment logic.

### DETAILED DESCRIPTION OF THE PREFERRED EMBODIMENT

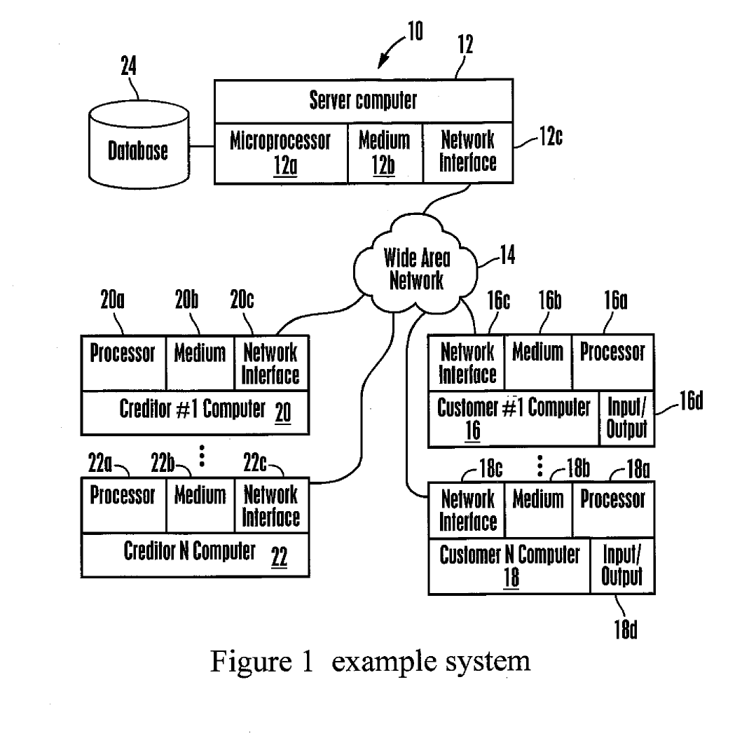

Referring initially to FIG. 1, a system 10 includes a server computer 12 communicating via a wide area network 14 such as the Internet with multiple customer computers 16, 18 and multiple creditor computers 20, 22 for purposes to be shortly disclosed. The server computer 12 may be used to establish an aggregated debt payment service as described herein. Note that as used herein, “customer” refers to a customer who uses the below-described aggregated debt payment service that may be hosted in whole or in part by the server 12 to automatically pay debts of the customer to creditors of the customer. Accordingly, “customer” may be used interchangeably with “debtor” herein.

In the example shown, the server computer 12 can have one or more processors 12a accessing one or more computer memories 12b, such as disk-based or solid state storage, to execute logic disclosed herein. The server computer 12 can communicate with the WAN 14 using one or more network interfaces 12c, such as wired or wireless modems, wireless telephony transceivers, WiFi transceivers, and the like. Also, the processor 12a may access a database 24 of customer accounts and creditor information.

The customer computer 16 can have one or more processors 16a accessing one or more computer memories 16b, such as disk-based or solid state storage, to execute logic disclosed herein. The customer computer 16 can communicate with the WAN 14 using one or more network interfaces 16c, such as wired or wireless modems, wireless telephony transceivers, WiFi transceivers, and the like. Typically, the customer computer 16 includes one or more input/output devices 16d such as but not limited to video displays, audio speakers, and printers (for output), and keyboards, keypads, voice recognition software with microphone, mice, trackballs, joysticks, touch sensitive displays, touch sensitive trackpads, and other types of point-and-click devices (for input). The customer computer 16 may be implemented by a desktop computer, a laptop or notebook computer, a slate computer, a smart phone, a tablet computer, a personal digital assistant (PDA), etc.

In general, the n^{th} customer computer 18 can have one or more processors 18a accessing one or more computer memories 18b, such as disk-based or solid state storage, to execute logic disclosed herein. The customer computer 18 can communicate with the WAN 14 using one or more network interfaces 18c, such as wired or wireless modems, wireless telephony transceivers, WiFi transceivers, and the like. Typically, the customer computer 18 includes one or more input/output devices 18d such as but not limited to video displays, audio speakers, and printers (for output), and keyboards, keypads, voice recognition software with microphone, mice, trackballs, joysticks, touch sensitive displays, touch sensitive trackpads, and other types of point-and-click devices (for input).

Turning to the creditor computer 20, it typically may be implemented as one or more server-type computers as well as, less typically, a personal computer such as one of those described above. Accordingly the creditor computer 20 can have one or more processors 20a accessing one or more computer memories 20b, such as disk-based or solid state storage, to execute logic disclosed herein. The creditor computer 20 can communicate with the WAN 14 using one or more network interfaces 20c, such as wired or wireless modems, wireless telephony transceivers, WiFi transceivers, and the like. In general, the n^{th} creditor computer 22 can have one or more processors 22a accessing one or more computer memories 22b, such as disk-based or solid state storage, to execute logic disclosed herein. The creditor computer 22 can communicate with the WAN 14 using one or more network interfaces 22c, such as wired or wireless modems, wireless telephony transceivers, WiFi transceivers, and the like.

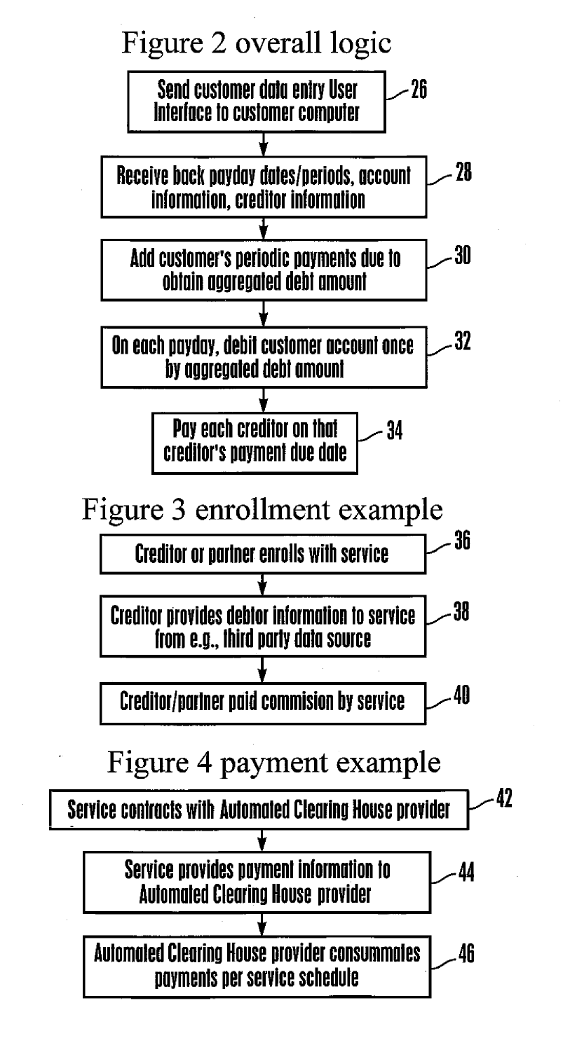

FIG. 2 shows example overall logic that can be executed by the server computer 12 in cooperation with the customer computers and creditor computers shown in FIG. 1. Commencing at block 26, a customer computer can access a web site associated with the server computer 12 and receive a data entry user interface. In other embodiments the customer can be prompted by the web site or other source (radio or TV advertisements, for instance) to telephone a call center affiliated with the server 12. In other embodiments a creditor or salesperson can enroll a debtor customer with the server 12 according to further description below.

Regardless of how the customer information is provided, at block 28 the server computer 12 receives (automatically through a web page or by data entry by a person speaking with the customer or from a creditor or salesperson as discussed further below) customer information including dates on which the customer receives periodic remuneration, such as a paycheck, regular royalty payments, regular interest payments, annuity payments, social security payments, and the like. As an example, a customer may be paid bi-weekly, every other Friday. In most months this results in two paychecks; in some months it may result in three paychecks. Knowing the dates on which the customer receives regular remuneration permits the customer's account to be debited on those dates and the customer's account balance maintained by the server computer 12 to be optimized thereby without delay and possible increased finance charges to creditors.

The customer information also typically information as to the customer's personal account into which the regular remuneration is deposited by, e.g., an employer of the customer. This information includes bank name, account number, and other information, including customer authorization forms or records, that authorize the entity affiliated with the server 12 to withdraw funds from the customer's account. The customer may use multiple accounts from which funds are to be withdrawn for creditor payments, in which case multiple account information may be maintained by the server 12, e.g., in the database 24. In some cases the customer account information may include an authorization for a payer organization to direct deposit the customer's regular remuneration, or a predefined portion thereof, directly into the customer's account balance maintained by the server computer 12, thereby bypassing the need for the server 12 to access a separate customer account and transfer funds into the account balance maintained by the server computer 12 and thence to creditors. In any case, the customer information is maintained with a customer identification, address, and other ancillary information in, e.g., the database 24.

Additionally, the customer information includes information on the customer's creditors. Specifically, the customer information includes, for one or more creditors of the customer, the creditor name, creditor payment information, e.g., address to which a payment to the creditor is to be made or an account of the creditor to which funds from debtors of the creditor are to be transferred, e.g., by wire. Also, creditor payment information includes for each creditor the dates on which payment is due from the customer, and the amount of each periodic payment. Thus, the customer's credit accounts typically are associated with respective periodic payment dates such as vehicle loan payments or home mortgage payments, or even periodic credit card or debit card payments the amounts of which may be defined by the customer, e.g., a minimum credit card payment amount. For example, one creditor may require payment on the fifth day of each month, another on the tenth, and so on. Typically, creditors require payments once per month, but in the case of creditors that require payment more or less frequently, such information is contained in the customer's account information maintained by the server computer 12.

In some cases the customer informs the server 12 of the payment requirements of each of the customer's creditors. In other case the customer informs the server only of the name of the creditors of the customer, and the server can access a computer affiliated with a particular creditor to obtain information as to when that creditor expects payment from its debtors.

Once the customer information above has been gathered, the server 12 periodically executes the logic at block 30, in which the server adds together the customer's periodic payments due each month to obtain an aggregated debt service amount. In cases in which the customer account is to be decremented on twice-per-month customer paydays, the aggregated debt service amount for the month is divided by two to render a pro rata aggregated debt service amount. In months in which the customer might happen to receive three periodic remunerations, the aggregated amount for the month may be divided by three to render a pro rata aggregated debt service amount. The logic then moves to block 32, in which, at each customer pay date for the month, the pro rata aggregated debt service amount is deducted from the customer account (or in the alternate embodiment described above is received direct from the customer's payer when the customer's account is to be bypassed).

The above deduction of the pro rata aggregated debt service amount from the customer account preferably is executed in a single debit transaction. That means that the customer is charged only once, for a single transaction, although the proceeds of that transaction are used to pay multiple creditors. This saves the customer money. The money so obtained is credited to the customer's account balance maintained by the server computer 12 in, e.g., the database 24.

Next, at block 34, for each creditor of the customer, on the date on which the customer payment is due, the server 12 automatically causes the customer's payment for that creditor to be deducted from the pro rata aggregated debt service amounts in the customer's account balance maintained by the server computer 12 and sent, e.g., by wire, to the respective creditor. In cases in which payment it made by check through the mail, the check is typically generated and mailed one or more days in advance as appropriate to be received by the creditor on the payment deadline. In this way, creditor payment is optimized by automatically and transparently to the customer paying each creditor preferably on the last day payment is due without late payment charges or penalties.

The above system lends itself to further advantageous processing. Specifically, by accessing the debtor's account and making deductions every two weeks at block 32 during the course of a calendar year, twenty six deductions of the pro rata aggregated debt service amount are made per year, with twenty four of the deductions being one-half each of a month's aggregated debt service, meaning that an extra month's aggregated debt service amount (two biweekly deductions) is deducted from the debtor account. This extra month's debt service amount can be used to establish a debtor enrollment fee which pays for the above service on the part of the debtor. Only a single year's enrollment may be required no matter how long the customer uses the service or how many additional debts the debtor adds to the automatic payment feature executed at block 34. In this way, the debtor does not have to pay for the service up front, with payment being made automatically and transparently to the service according to the above.

Additionally, the extra month of aggregated debt service amount can be used to pay commissions to creditors and/or salespersons who enroll customers in the service. The commissions can be tailored for each situation, and can result in, e.g., an enrolling creditor to be paid the first “n” dollars of the aggregated debt service amount, an enrolling salesperson the next “n” dollars, and so on, with any remaining residual of the extra month's aggregated debt service amount being round-robined back to one of the previously paid enrollers. Note that round-robin may not be used, but some other paradigm may be used instead. In any case, creditors and salespeople are incentivized to enroll customers in the service hosted by the server 12.

Note that the customer may be given the alternative option to have deducted every two weeks an amount marginally larger than the customer's pro rata aggregated debt service amount to augment or establish the enrollment fee, with the extra month's deduction of the aggregated debt service amount being waived once per calendar year.

FIGS. 3 and 4 show non-limiting example logic of implementing debtor enrollment and making creditor payments, using if desired automated clearing house (ACH) transfer. Customer (debtor) data may be obtained through multiple channels, and in one embodiment is obtained through one of three channels. Commencing at block 36 in FIG. 3, a creditor/partner of the payment service enrolls with the aggregated debt payment service. The creditor/partner can be a finance manager at dealership or a direct-to-consumer loan agent. Enrollment may be through a web portal of the aggregated debt payment service, e.g., hosted by the server 12 shown in FIG. 1. Note that debtor permission may be required prior to the creditor/partner enrolling the debtor's loan into the aggregated debt payment service.

At block 38, the creditor/partner provides debtor information to the aggregated debt payment service. This information may be obtained from third-party data sources such as automated data processing sources. While each third-party data source may have a different integration process, the result is the ability to enter a deal identification into the aggregated debt payment service server, which then automatically accesses the third-party data source to pull customer (debtor) information directly into an enrollment database. This information can include financing information including debtor account number, address, email, name, phone numbers, etc. The creditor/partner may also request of the customer, for provision to the server 12, the customer's pay dates, account number into which the customer's salary is paid, routing number, and other information necessary to enable the server 12 to automatically deduct the pro rata aggregated debt service amount discussed above from the account and place the pro rata aggregated debt service amount into the customer's account held at or under control of the server 12. If the customer cannot provide this information at time of sale, the enrollment can proceed apace and the server 12 can email or otherwise contact the customer for the necessary information a day or two later.

At block 40 originators such as creditor/partners described above can be paid commissions by the aggregated debt payment service for debtor accounts they originate. A flexible commission system may be used that enables payment to as many originators as desired up to the amount of the enrollment fee, which is paid by the debtor as described above. The order of who gets paid is customizable and payees can get paid multiple times within the entire cycle of commissions. A partner can have multiple deals with the aggregated debt payment service so they can be the source originator on one deal and act as a sales manager or agent on another deal. If desired, commissions can be generated from “accelerated debits” on biweekly and weekly debit schedules. Semi-monthly and monthly customers can only generate a commission if a customer agrees to a debit that is increased by 1/12 (semimonthly) or 1/24 (monthly) of regular monthly payment to their lender. Partners can be paid up-front or from accelerate debits depending on the commission structure.

In addition to obtaining debtor information from creditor/partners, a back-end interface can be provided by the aggregated debt payment service server 12 that allows independent sales teams to work groups of leads, for example pulled electronically from a vehicle dealership management system (DMS) once a day and including the previous days sales. This primary sales campaign may be colloquially referred to as a “no-hassle” integration as allows vehicle dealerships to offer the service plan described in FIG. 2 via a telesales call. When a sales person enrolls a customer they get paid a commission along with the dealership from which the sales lead was obtained. Typically a sales manager and agents/agencies may be paid as well.

As a third route for obtaining debtor information, customer/debtors can call or email the aggregated debt payment service directly to enroll and provide the requisite information discussed above. Note that for customer/debtors that are enrolled through a third-party data source that supports real time communication, the aggregated debt payment service can query their systems for an update a few days after the enrollment to ensure data correctness. If critical fields do not match a warning message may be sent to the originator.

Furthermore, a publicly accessible credit card database can be accessed by the aggregated debt payment service server to insure the aggregated debt payment service has the correct loan account number into which electronic payments are to be made to creditors that are in the credit card network. This may be updated once a month.

If desired, the aggregated debt payment service can implement an automated telephone campaign which calls debtors for whom critical data is erroneous or is missing as indicated by a failed debit or payment. Emails may be sent to such debtors with contact information of the aggregated debt payment service with instructions to contact the aggregated debt payment service. Yet again, representatives of the aggregated debt payment service can obtain any missing financial or other debtor data such as account data, loan data, etc, can call debtors to obtain the necessary information.

Turning to FIG. 4 for an example implementation of the payment logic of blocks 32 and 34 of FIG. 2, the aggregated debt payment service can contract at block 42 with an ACH provider that executes electronic debits (from the aggregated debt payment service to creditors) and credits to and from the debtor account held by the aggregated debt payment service. The aggregated debt payment service provides payment information to the ACH provider at block 44. The aggregated debt payment service can electronically transfer debtor loan payments deducted by the aggregated debt payment service from the debtor account held by the aggregated debt payment service using an ACH Credit, which typically arrives at the relevant creditor in two business days. Debits typically are made from the debtor's account by the aggregated debt payment service one business day before the debtor expects them to leave to ensure the payment is made on time. Credits into the debtor's account held by the aggregated debt payment service may take two business days to arrive next day credits may be provided for. At block 46 the ACH provider consummates payments received from the aggregated debt payment service to the relevant creditor according to the schedules established by the service.

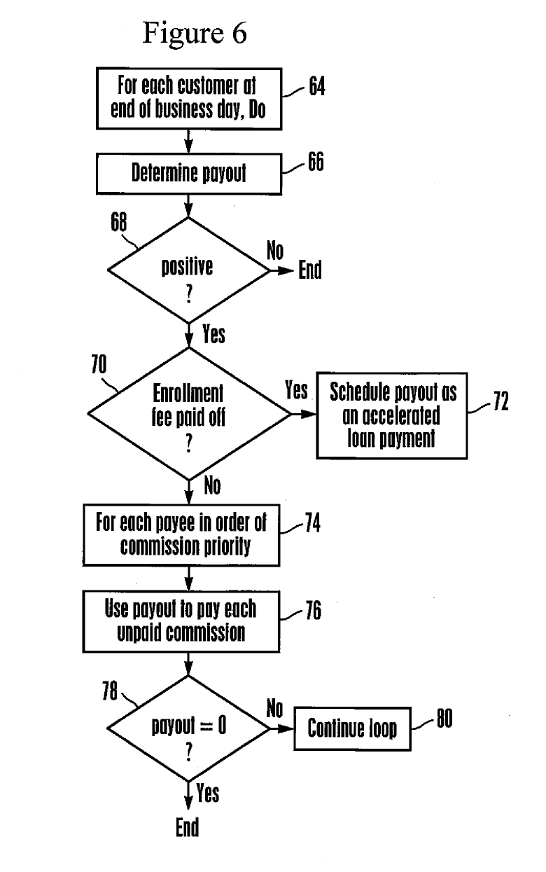

Note that extra funds can be collected from debtors that can be used for commissions or accelerated loan payoffs. A customer/debtor can have two or more loans on the same debit schedule with accelerated funds being used to pay off the highest interest bearing loan first. Further details are discussed below in reference to FIG. 6.

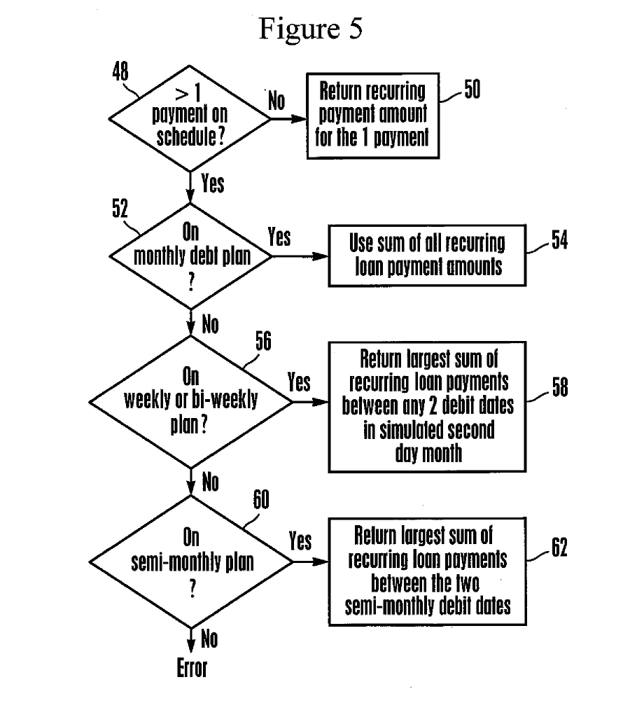

FIG. 5 illustrates an example of how the amount to deduct from a customer's account on a recurring basis may be determined. The definitions below are first provided, and then a description of FIG. 5 ensures.

| Name | Description |
|---|---|
| Debit | Withdrawal from client bank account into |
| | Smart balance, that has not returned. |
| Debit Obligation | Pending withdrawal from client bank |
| | account into Smart balance. |
| Debit Fees | Fee added to each debit that Smart collects. |
| Refund | Deposit (or pending deposit) into customer |
| | bank account, from customer's smart |
| | balance, that has not returned. |
| Loan Payment | Payment to creditor from customer's smart |
| | balance, that has not returned. |
| Accelerated Loan Payment | Payment (or pending payment) to creditor |
| | from customer's smart balance. Generated |
| | from the acceleration process of FIG. 6. |
| Loan Payment Obligation | Pending payment to creditor from customer's |
| | smart balance. |
| Enrollment Fee | The deferred service charge which is used to |
| | pay commissions. Collected automatically |
| | using the acceleration process of FIG. 6. |
| Payee | Someone who receives part of the enrollment |
| | fee. Each payee can be paid multiple times |
| | in any priority and amount. |

Balance Definition: Balance = Debit − Debit Fee − Refund − Loan Payment − Accelerated Loan Payment − Enrollment Fee
Pending Balance Definition: Pending Balance = Balance + Debit Obligation − Loan Payment Obligation

With the above in mind, FIG. 5 shows logic for determining a minimum amount of a customer's money to hold for the next scheduled payment. While FIG. 5 is in flow chart format for ease of description, in implementation state logic can be used to, for example, lookup the type of monthly debit plan the customer is on.

If it is determined at decision diamond 48 that the customer has only one recurring payment on their debit schedule, then at block 50 the recurring payment amount for that payment is returned.

For customers with more than a single recurring payment on their debit schedule, the logic determines at decision diamond 52 whether the customer is on a once-per-month debit plan, i.e., has selected to have their account debited for bill payment once per calendar month. If so, the sum of all recurring loan payment amounts is determined and used to pay the various creditors.

On the other hand, if the customer is not on a monthly payment plan, as represented by decision diamond 56 the customer may be on a weekly or bi-weekly plan, i.e., a plan in which the customer's account is debited once per calendar week or once per every two calendar weeks. If so, at block 58 the sums of the recurring loan payments between any two debit dates for a simulated (projected) 28 day month are calculated and compared against each other, and the largest sum is used as the amount the customer's account is debited every week or every bi-week as the case may be. For example, for a weekly plan the sums of the recurring loan payments for a first week are calculated and compared against the sums of the recurring loan payments for a second week, and the largest sum is deducted each time. This is how a surplus “payout” discussed further below can be generated.

Then again, as represented by decision diamond 60 the customer may be on a semi-monthly plan, meaning account deductions are to occur twice per calendar month, e.g., on the first and sixteenth day of each month. In this case, at block 62 the sums of the recurring loan payments in the first half of the month and in the second half of the month are calculated and compared against each other, and the largest sum is used as the amount the customer's account is debited each time the account is debited.

FIG. 6 shows that if desired, for each customer at the end of each business day an acceleration process occurs starting at state 64. The purpose is to determine if there are funds that can be applied to the Enrollment Fee or as an Accelerated Loan Payment. At block 66 the “payout” is determined as follows: Base Payout=Base Balance−Minimum Hold amount calculated from FIG. 5. The lower amount between the Base Payout and the Pending Balance is used as the “Payout” amount in FIG. 6.

If it is determined at decision diamond 68 that the payout is positive, the process moves to decision diamond 70 to determine whether the customer's enrollment fees have been paid off. If it has, the payout is scheduled to be paid to creditors as an accelerated loan payment, to save the customer interest charges. If the enrollment fees have not yet been paid off, however, the logic moves to block 74 to enter a loop over each payee in order of commission priority, in which at block 76 the payout is used to pay each unpaid commission until the payout is zeroed out at decision diamond 78. Until the payout is zero, the loop continues at block 80 to pay each successive payee in order of their commission priority until all commissions have been paid or until the payout is zeroed out.

While the particular AUTOMATIC CONSUMER DEBIT AND PAYMENT SYSTEM is herein shown and described in detail, it is to be understood that the subject matter which is encompassed by the present invention is limited only by the claims.

1. Computer system comprising:
at least one computer readable storage medium accessible to the processor with instructions which when executed by at least one processor configure the processor to:
access customer income receipt information associated with a customer, the customer income receipt information indicating when the customer receives income at respective future dates and/or times;
access information related to at least first and second creditors to which the customer owes respective first and second payments;
add the first and second payments together to render an aggregated payment;
at one or more of the future dates and/or time, debit an account of the customer by at least a portion of the aggregated payment in a single debit transaction such that the customer account is debited only once to cover both the first and second payments;
from the aggregated payment, remit to the first and second creditors the respective first and second payments,
debit at least a portion of an aggregated debt service amount from the account of the customer every two weeks for a calendar year such that an extra month's aggregated debt service amount is deducted from the account of the customer during the calendar year;
use at least part of the extra month's debt service amount to establish an enrollment fee at least part of which is payable to an entity affiliated with the computer and/or an enrollment agent who enrolled the customer with the computer.

2. The computer of claim 1, wherein the customer income receipt information indicates a periodicity at which the customer receives payment from an employer.

3. The computer of claim 1, wherein the instructions when executed by the processor configure the processor for debiting the account of the customer by at least the portion of the aggregated payment in a single debit transaction at each of plural future dates and/or times.

4. The computer of claim 3, wherein the first and second payments are recurring charges owed to the respective first and second creditors.

5. The computer of claim 1, wherein the instructions when executed by the processor configure the processor for debiting an account of the customer by at least the portion of the aggregated payment in a single debit transaction more than once per month.

6. The computer of claim 1, wherein the instructions when executed by the processor configure the processor for remitting to the first and second creditors the respective first and second payments only once per month.

7. The computer of claim 1, wherein the instructions when executed by the processor configure the processor for receiving from the customer the customer income receipt information, the customer income receipt information indicating monthly dates on which the customer periodically receives income.

8. The computer of claim 1, wherein the instructions when executed by the processor configure the processor for debiting an account of the customer by at least the portion of the aggregated payment in a single debit transaction every two weeks for a calendar year.

9. (canceled)

10. The computer of claim 9, wherein only a single year's enrollment is required from the customer no matter how long the customer uses the service or how many additional debts the customer debtor adds to the service such that the customer does not have to pay for the service up front, with payment being made automatically and transparently to the service.

11. Computer system comprising:
at least one computer readable storage medium with instructions which when executed by at least one processor configure the processor for:
debiting at least a portion of an aggregated debt service amount from an account of a customer every two weeks for a calendar year such that an extra month's aggregated debt service amount is deducted from the account of the customer during the calendar year;
using at least part of the extra month's debt service amount, establishing payment for an enrollment fee at least part of which is payable to an entity affiliated with the computer and/or an enrollment agent who enrolled the customer with the computer; and
automatically pay multiple customer creditors from amounts debited from the account of the customer.

12. The computer of claim 11, wherein only a single year's enrollment is required from the customer no matter how long the customer uses the service or how many additional debts the customer debtor adds to the service such that the customer does not have to pay for the service up front, with payment being made automatically and transparently to the service.

13. The computer of claim 11, wherein the instructions when executed by the processor configure the processor for:
accessing customer income receipt information associated with the customer, the customer income receipt information indicating when the customer receives income at respective future dates and/or times;
accessing information related to at least first and second creditors to which the customer owes respective first and second payments;
adding the first and second payments together to render an aggregated payment;
at one or more of the future dates and/or time, debiting an account of the customer by at least the aggregated payment in a single debit transaction such that the customer account is debited only once to cover both the first and second payments; and
from the aggregated payment, remitting to the first and second creditors the respective first and second payments.

14. The computer of claim 13, wherein the customer income receipt information indicates a periodicity at which the customer receives payment from an employer.

15. The computer of claim 13, wherein the instructions when executed by the processor configure the processor for debiting the account of the customer by at least the aggregated payment in a single debit transaction at each of plural future dates and/or times.

16. The computer of claim 15, wherein the first and second payments are recurring charges owed to the respective first and second creditors.

17. The computer of claim 13, wherein the instructions when executed by the processor configure the processor for remitting to the first and second creditors the respective first and second payments only once per month.

18. The computer of claim 11, wherein the instructions when executed by the processor configure the processor for receiving from the customer the customer income receipt information, the customer income receipt information indicating monthly dates on which the customer periodically receives income.

19. Method comprising:
receiving customer paycheck and creditor information at a server implementing an aggregated debt payment service;
using the server to determine a customer's aggregated monthly payments on periodic accounts;
on each payday of the customer, using the server to deduct a fraction of the aggregated monthly payment in a single transaction, resulting in only a single fee to the customer, the fraction depending on how many times per month the customer is paid;
holding the customer's funds in a service account; and
on days that payment for a respective creditor of the customer is due, paying the respective creditor out of the service account automatically and transparently to the customer.

20. The method of claim 19, wherein the fraction of the aggregated monthly payment establishes at least part of an aggregated debt service amount and an extra month's aggregated debt service amount is deducted from service account on behalf of the customer during a calendar year, and the method further comprises:
using at least part of the extra month's debt service amount, establishing an enrollment fee at least part of which is payable to an entity affiliated with the server and/or an enrollment agent who enrolled the customer with the server.
